(19) United States
(12) Patent Application Publication
(10) Pub. No.: US 2013/0286048 A1
(43) Pub. Date: Oct. 31, 2013

(54) METHOD AND SYSTEM FOR MANAGING DATA IN TERMINAL-SERVER ENVIRONMENTS

(71) Applicant: Christian STERNITZKE, Leipzig (DE)

(72) Inventor: Christian STERNITZKE, Leipzig (DE)

(21) Appl. No.: 13/869,489

(22) Filed: Apr. 24, 2013

Related U.S. Application Data
(60) Provisional application No. 61/637,953, filed on Apr. 25, 2012.

(51) Int. Cl. G06T 19/00

(52) U.S. Cl. CPC G06T 19/006
USPC 345/633

(57) ABSTRACT

A system and method of providing augmented reality (AR) information uses a camera to take images from a mobile device's environment. These images are compared to images stored in an image-object database to identify objects within these images. The objects are compared to objects stored in a database with AR information to display the AR information as an overlay of the real image on the mobile device. The AR information is generated from a mobile device user preference database. The preferences are matched with a second user's preferences obtained from data mining activities across a store management system, ERP system, CRM system, data on sales figures tied to customer data, and the like. An additional image-object localization database provides detailed localization information for objects identified. The store management system, ERP, or CRM system can facilitate electronic analysis of products, sales and customer data.

### TECHNICAL FIELD

The invention relates to a mobile device, a server, a system and a method to provide augmented reality (AR) information stemming from data mining activities.

### BACKGROUND

Mobile devices can be utilized to display location-based augmented reality (AR) information. Typically, a mobile device possesses sensors such as a camera which takes images of the mobile device's environment. These images are then enhanced with augmented reality information tied to certain locations. Often, such information is received via a network interface from a server and a database. Applications of AR information are often given for navigation purposes in cities, displaying information about sights and buildings.

Prior examples describe methods and systems to display product or service offerings, advertisements, and marketing research data stemming from multiple databases and connected to client computers. However, the described methods and systems relate to elicit user preferences, not using user preferences for certain objects, especially in the AR environment. Other work relates to a system and method to recommend items in an online store, where the items are displayed based on similar items previously selected by the user. The degree of similarity between items determines how far items are displayed.

### SUMMARY

The claimed invention relates to a mobile device, a server, a system, and a method to provide augmented reality (AR) information. The mobile device uses a sensor such as a camera to take images from the device's environment. These images are compared to images stored in a database (an image-object database) to identify objects within these images. The objects are then compared to objects stored in a second database (database with AR information) within a network to provide augmented reality (AR) information on a display of the mobile device as an overlay over a real-world image. The AR information is generated based on at least one database that reflects the mobile device's users' preferences (user preference database). These preferences are matched with those of a second user and possibly obtained from data mining activities across a store management system, enterprise resource planning (ERP) system, customer relationship management (CRM) system, data on sales figures tied to customer data, and the like. Such information is either generated in real-time, or is stored in one or more further databases (database with customer and product data). An additional database provides detailed localization information for objects identified (image-object localization database). The store management system as well as the ERP or CRM system may be connected to an electronic cashier system. The claimed invention further includes a method, system and server to conduct these steps.

The invention further includes the use of eye tracking in a head-mounted display connected to an AR device, system, server infrastructure, and method for prioritizing object identification, where the object identification is used to provide AR information. Such prioritization advantageously lowers the data rate to be transferred over a mobile communications network (with often shared bandwidth among multiple users within a radio cell), which potentially increases latency rates of the information to be displayed.

### BRIEF DESCRIPTION OF THE DRAWINGS

FIG. 1 shows a system for providing AR information, including the mobile device (100), a network (200), multiple servers (300) with a processor (310) and a memory (320), and databases (400), which may be connected to an electronic cashier system (500) over a network.

FIG. 2 shows the position sensors (152), which may include (jointly or solely) GPS, accelerometers, gyroscopes, LAN/Wi-Fi triangulation, image sensors, and/or RFID.

FIG. 3 demonstrates the server network infrastructure with multiple databases.

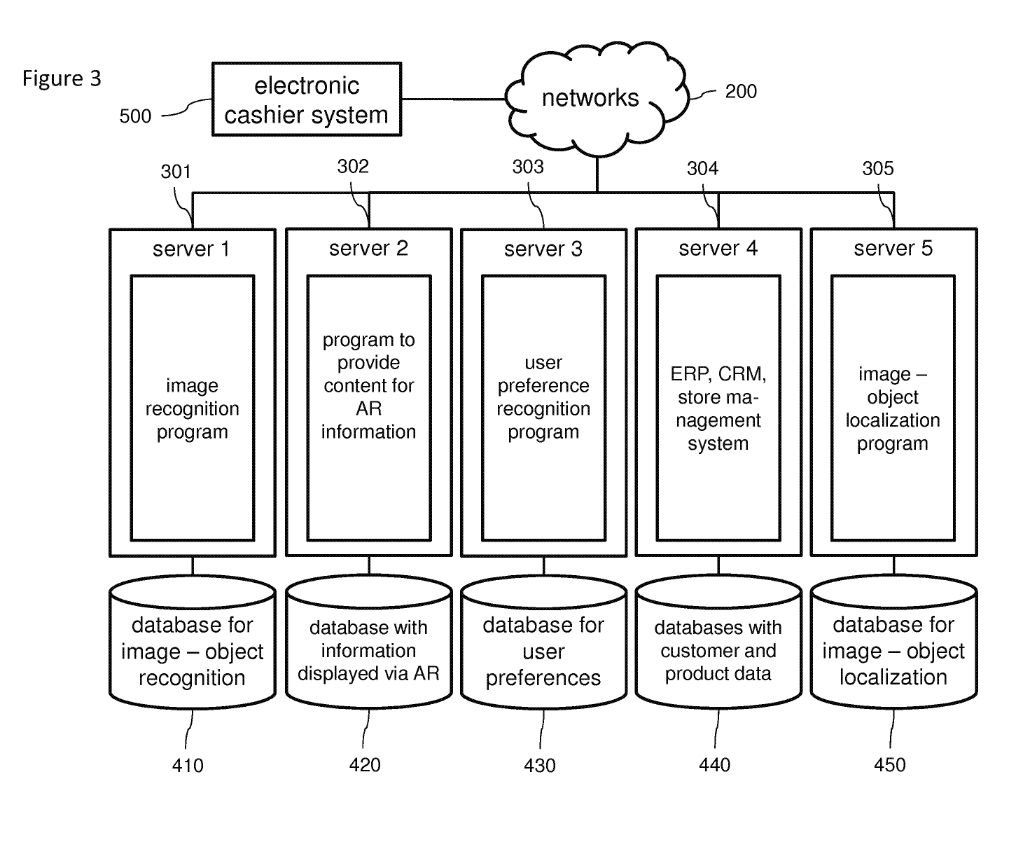

### DETAILED DESCRIPTION

The claimed invention may, however, be embodied in many different forms and should not be construed as limited to the embodiments set forth herein. Rather, these exemplary embodiments are provided so that this disclosure is thorough, and will fully convey the scope of the invention to those skilled in the art. Also, descriptions of well-known functions and constructions may be omitted for increased clarity and conciseness.

The architecture of the invention follows a client-server architecture, as can be the case for AR applications (see e.g., US2008071559 and US2011187745 the entire contents of which are incorporated by reference herein).

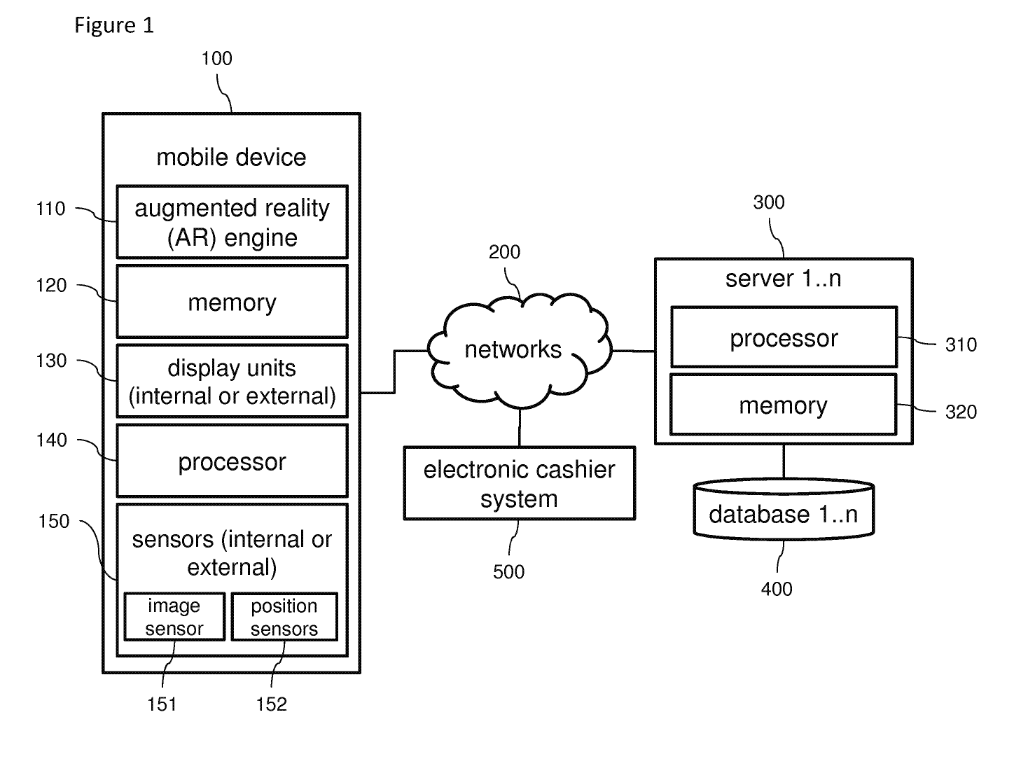

FIG. 1 discloses a mobile device (100) having an augmented reality engine (110), at least one memory (120), at least one display unit (130), at least one processor (140), and at least one sensor (150).

The mobile device is connected to a communication network (200), e.g. a wireless network such as wireless LAN, WiMax, Wi-Fi, or a mobile communications network (e.g., LTE advanced, LTE, HSPA, HSDPA, UMTS, EDGE, CDMA, GPRS, GSM, etc.).

The display unit (130) may be integrated into the mobile device, or it may be external, such as a head-mounted display (see e.g., US2012050144 for head-mounted displays and AR applications) or contact lens (see DOI: 10.1117/2.1200905.1154). The display may be a LCD display, an OLED display, or a pico projector (based on LEDs or laser diodes).

The processor (140) is connected to the network interfaces, the sensors, and the displays.

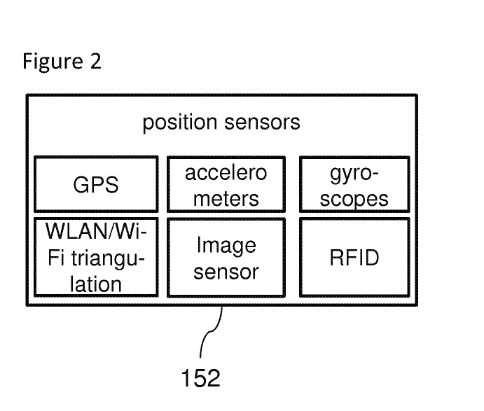

The mobile device contains at least one sensor (150). The sensors may be incorporated into the mobile device, or they may be external (e.g., peripherals coupled to the mobile device, using. interfaces, for example). One sensor may be an image sensor (151) such as a charge-coupled detector (CCD) used as a camera. Further sensors may be positioning sensors (152), such as GPS, gyroscopes, accelerometers, proximity detectors (e.g., Radio Frequency ID tags, short-range radio receivers, infrared detectors) but also wireless location systems using e.g. wireless LAN/Wi-Fi or mobile communication networks including femto cells for position tracking. The use of one or multiple positioning sensors may be associated with further database use, possibly over a (communications) network, e.g., to obtain information on triangulation of wireless location systems using data on WLAN/Wi-Fi. See also FIG. 2 for these example embodiments.

The memory (120) is coupled to the processors, the memory including instructions that cause the processors (140) to obtain information on the current location of the mobile device, using sensor data as described above. The processor also obtains image data from the image sensors as mentioned above. The processors then correlates images obtained from the image sensor with reference data obtained from a database (410) to identify objects within the images. The correlation of image data has been described for AR in U.S. Pat. No. 8,036,678, the entire content of which is incorporated herein by reference. The first database (410) contains data to identify objects (image-object recognition database) and may be either contained in the memory of the device, or it may be accessible via a network interface. When used in the memory of the device, the memory may serve as a proxy, similar to an Internet proxy server, storing those objects which are likely to be identified frequently or have been identified in the past. Correlating images from a sensor with image data from this database (410) in real-time requires substantial bandwidth via mobile communication networks, which is available with LTE technology. Using relevant object data from the local memory reduces the amount of data to be transferred via the communications network. The processor then causes the display to show a real-world image together with AR information linked to certain objects almost in real-time, as depending on the speed of movement of the mobile devices user', timely information is necessary.

The AR information is obtained from a second database (the AR information database), either from the mobile device's memory or via a network interface (420). The corresponding server and memory may serve as coordinating units over more servers, memories and databases, providing additional data (see servers 303 and 304). The database 420 can be generated on the fly based on data from other databases such as 430 and 440. The real-world image may either be recorded by a camera and then displayed by a display, or it may emerge from seeing through (semi)transparent glasses where displays are projecting images or AR information into, such as see-through head-mounted displays or head-up displays, used for example in cars and other vehicles.

The objects identified may further be used to specify the location of the device, especially to improve the results from other sensor data. Such information may be used jointly with the direction from which the images where taken. The information on the location of the objects is obtained from a database (450—the image-object localization database) accessible via a network interface.

Prioritization of objects to identify may take place via eye tracking, which reduces the amount of data that must potentially be transferred between the mobile device and a server, using a mobile communications network. Such networks have a shared bandwidth within a radio cell. When multiple users are using data intense applications, the bandwidth for the specific user with the AR device is reduced, which may increase latency. Hence, prioritization of objects via eye tracking may be an option to offer relevant information also when bandwidth is limited. In addition, using a reduced amount of data also reduces the energy required in the mobile device to transfer such data, which prolongs battery use time. This may also allow the use of smaller batteries, reducing the weight of the mobile device. Both are technical parameters for designing mobile devices.

The information displayed via the AR engine is adjusted to preferences stored in a database stemming from the mobile devices' user (430—the user preference database), and is obtained either from the mobile devices' memory or accessible via a network interface. These preferences can be compared in real-time to preferences from third parties stored in one or multiple databases (e.g., 440—customer and product data databases), which are then compared and matched. Both the user preference database and the customer and product databases may be preference databases. Such data can originate from data mining activities, for instance from the retail industry or across social media data. Real-time preference-matching often requires large bandwidth in mobile communication networks, which have not been available in the past.

It is also possible to omit database 430—the user preference database, and solely use data from third parties originating from databases such as 440 (customer and product data databases).

The customer and product data database (440) may also be connected to a store a management system, an enterprise resource planning (ERP) system, a customer relationship management (CRM) system, and systems in general that allow the electronic analysis of products, sales and customer data, including social media data, comprising information on e.g. inventories, prices, etc. The store management system, an enterprise resource planning (ERP) system, a customer relationship management (CRM) system, and systems in general that allow the electronic analysis of product, sales and customer data, including social media data, may be connected to an electronic cashier system.

Real-time preference matching also has the advantage that very recent information, for instance from database 440, may be included, which increases accuracy of the preference matching.

AR data may be combined with position information to measure the distance of objects from the AR device, or the multiple sensors may be used to track the position of a device. Objects with AR information can be managed within a display by eliciting the size of objects in real-time to support navigation purposes, e.g., in cars.

There may also be image sensors for eye tracking, e.g., within head-mounted displays, which use, for example, eye-tracking to support the alteration of real-world images in order to enhance the visibility of displayed AR information. Eye-tracking may be used to identify the distance of objects from the AR device. This may include eye tracking through image sensors included into displays.

The claimed invention further relates to a method that may be executed entirely or in part in the memory of a mobile device. The method comprises the following steps: (i) obtaining the current location of the mobile device by means of sensors such as GPS, gyroscopes, accelerometers, proximity detectors (e.g., Radio Frequency ID tags, short-range radio receivers, infrared detectors, and the like) but also wireless location systems using e.g., wireless LAN/Wi-Fi or mobile communication networks including femto cells for position tracking (152); (ii) obtaining images via a sensor such as a charge-coupled detector (CCD) used as a camera (151); (iii) correlating images obtained from one sensor with reference data obtained from a database (410—the image-object database), either in the memory of a mobile device or accessible via a network interface, to identify objects within the images; and (iv) displaying a real-world image together with augmented reality information that is linked to certain objects on the mobile device's display and obtained from a database (420—the AR information database) via a communication network.

Information is displayed using a LCD, OLED-display, laser or LED-projector, head-mounted display, or contact lens incorporating light-emitting diodes.

The location of the objects may be further specified by means of the objects identified via the images, which are compared to reference objects with location information stored in a further database (450—the image-object localization database) accessible via a communication network.

Objects may be prioritized via eye tracking as described above.

The method also indicates that the information displayed via augmented reality is adjusted to preferences stored in a user preference database (430). This database (430) is stored in the mobile device's memory or is accessible via the interface of the communication network. The preferences from this database are compared, possibly in real-time, to preferences stored in further, possibly multiple databases (440—customer and product data databases), which possibly originate from third parties and/or different users. These different preferences originating from the mobile devices' user and third parties are then matched.

The information to be shown as augmented reality and stemming from a database with AR information 420 can be generated on the fly. This means that the information to be displayed as AR may either stem from database 420, or the information is generated in real-time from matching data from the database for image-object identification (410), the database with user preferences (430), the database with customer and/or product data (440) (e.g., a data warehouse), and/or the database for image-object localization (450). As an example, information may be elicited in real-time that a specific user has stored a shopping list in his mobile phone. The phone's user has entered a supermarket. The underlying system uses database 410 to identify objects such as bananas. The user receives AR information that these items in his field of view are on his or her shopping list (i.e. stored as preferences in database 430). A further scenario might be that additionally server 303 with database 430 recognizes that the user also has fresh milk on his or her shopping list. The images obtained from the mobile devices' camera enable server 305 to identify the exact location of the user in the store, including the exact viewing direction using data from database 450 (image-object localization database). This allows server 302 to display the direction the user has to follow to go to the shelf with fresh milk. On the way to this shelf, the user passes a shelf with cheese. Server 304 recognizes, based on data from database 440—customer and product data, that the user used to buy cheese in the past. Some types of cheese have an approaching expiration date, and given the amount of available cheese, the store should offer the cheese for a discounted price. Server 302 now displays, based on such relationships either stored in database 420, or generated e.g., in real-time from databases 430 and 440, the AR information that the cheese with approaching expiration dates is offered at a (potentially specific) discount.

The preferences in at least one database (440—customer and product database) may originate from data mining activities, possibly in the retail industry or across social media data. Data mining means the use of methods such as cluster analysis, regression analysis, support vector machines, neural networks, etc. to identify patterns in data. Patterns may include findings that certain types of customers (entering a store during a certain time span, of a certain age group, etc.) prefer buying certain items in a store. Preferences elicited through data mining may also reveal that such customers have bought similar items in the past or that their friends bought several items in the past. They may further reveal that the store has e.g., some grocery products on stock with approaching expiration dates, and that the amount on stock possibly extends the amount which is usually sold until the expiration date.

The further database (440—customer and product database) is connected to a store management system, an enterprise resource planning (ERP) system, a customer relationship management (CRM) system, and systems in general that allow the electronic analysis of product, sales and customer data, including social media data, which may be connected to an electronic cashier system. This cashier system may e.g., provide up-to-date information on current sales, coupons used, customer data (including anonymized customer data), etc. to the databases and data mining tools and potentially allows real-time management of e.g. special offers in a store environment.

The claimed invention further embodies an electronic cashier system (500) connected via a network (200) to a system or multiple systems, including a server each (301-305) and databases (410-450). One server (301) relates to providing data on object recognition via image data, having a corresponding database (410—the image-object recognition database). A further server (302) hosts data to be shown as information via the AR engine on the mobile device, stored in a corresponding database (420—the AR information database, whose information may also be generated on the fly by using data from the following databases). This server may serve as coordinating unit over servers 303 and/or 304. Another server (303) potentially hosts user preference data, stored in a corresponding database (430—the user preference database), including preference data from social media data analysis. One or more servers (304) execute a program to provide information from ERP, CRM, store management systems or further programs managing data on products, sales, and customers, including customers' buying behavior and social media activities, which are stored in one or more databases (440—customer and product databases). Another server (305) potentially hosts localization data for objects, stored in a corresponding database (450—image-object recognition database).

The one or more servers each comprise (i) a network interface capable of communicating via a network; (ii) one or more processors coupled to the network interface; and (iii) a memory coupled to the processor, the memory including instructions that cause the processor to provide information to a mobile (communication) device to (a) receive reference image data from a first database (410—the image-object recognition database) to correlate these data with image data which the mobile device obtains from one sensor and to identify objects within the images, and (b) receive information from a second server and/or database (420—the AR information database, whose data may be alternatively generated on the fly by further databases as subsequently explained) linked to certain objects on the mobile device's display(s), wherein the information are based on preferences, potentially stemming from a further database (430—the user preference database).

The information sent to the mobile device is compared, including in real-time, to preferences stored in a further database (440—the customer and product database), and a preference matching takes place. Alternatively, database 430 may be omitted, which means AR data is possibly based on third party preferences such as from a store owner. The databases may be accessible via the server, but they may also be distributed across a network and attributed to several servers, including a mobile communication network. Some of the databases mentioned herein may also be combined into a single database. The preferences in the databases may be of multiple users.

At least one database (440—customer and product database, or a subset of preference databases, or a data warehouse) comprises results based on data mining activities, for instance conducted in/for the retail industry, or across social media data. It may also be connected to a store management system or to an enterprise resource planning (ERP) system, where the store management system, an enterprise resource planning (ERP) system, a customer relationship management (CRM) system, and systems in general that allow the electronic tracking of product, sales and customer data, including social media data, is connected to an electronic cashier system.

The server 302 with its database 420—the AR information database—providing information to be displayed as augmented reality may serve as a coordinating unit over servers 303 and 304, generating the content of database 420 on the fly. In this case, database 420 is not necessarily required as the data generated on the fly may as well originate from the servers' memory or a data warehouse.

The timely identification of objects (e.g. in real-time) in the field of view of the mobile devices' user is important to display relevant information. Such as step is of particular importance when the user is moving, and hence an object is only in sight for a few seconds. Displaying AR information means that such object identification must have occurred in advance, and the user then usually needs several seconds to view and understand the AR information. However, in order to obtain AR information, this information must be generated first (but after object identification), based of at least preferences from a user or a third party such as a store. In cases where preference matching takes place between the user and e.g., a store owner, further time is required. This implies that information transfer to identify objects, possibly their location, generate content to be displayed as AR information must occur almost in real-time, often requiring low latency times and sufficient bandwidth.

The invention also embodies a system, including a mobile device and a server, as described above.

Examples of the claimed invention are described below:

### EXAMPLE 1

The user of a mobile phone enters a store. The person wears an additional head-mounted display with see-through glasses (coupling in image information) connected to the mobile phone. Alternatively, the phone may also be integrated into the head-mounted display. The head-mounted display also possesses a camera taking pictures from the direction where the person looks at (151). Taking such pictures may also be coordinated with eye-tracking. The mobile phone determines the approximate position of the device via GPS (152). Triangulation of wireless LAN networks/Wi-Fi and LTE femto cells allows determination of the exact position also within buildings. The mobile device links the location of the user to a certain store.

As the user walks through the store with its shelves, the position of the user is adjusted via the positioning sensors (152). The camera (151) records the products in the shelves. The images are compared to images stored in a database (410—image-object recognition database). The database comprises reference information to recognize products, i.e., it may comprise several images of e.g., bananas, and server 301 or the mobile device then recognizes that certain items in the field of view of the user recorded by the mobile device comprise the same patterns of bananas stored in database 410. Data transfer between the images from the database and the images recorded via the mobile device are transferred via an LTE network, and the mobile phone/system recognizes the products in the shelves. The user then can see additional (augmented reality) information in the head-mounted display relating to these products and stemming from server 302, while the user can see the real-world through the users' transparent glasses. If the user had recorded certain preferences in advance, those products may be tagged with specific information that is on the users' shopping list stored in the mobile phone or on a server. The preferences may also have been elicited through (past) user activities in social media.

### EXAMPLE 2

Following example 2, the mobile phone uses the objects identified to further specify its position in the store. Positioning data is obtained from a database via the network interface, either linked to the object identification data in general, or, more likely, from a store-specific database that unites product data with position data (e.g. from database 450—image-object localization database). Such detailed positioning may be used to guide to user to certain products which may be preferred, such as items listed on a shopping list stored in the mobile device.

### EXAMPLE 3

Following examples 1 and 2, the mobile phone can be set to only identify products the user is looking at, which the head-mounted display recognizes via eye-tracking. This approach allows lower data rates to be transferred between a mobile device (100) and a server (e.g. 301 with a corresponding database 410), and it potentially allows a lower energy consumption of the device.

### EXAMPLE 4

Following the preceding examples, special offers of the store owner are highlighted as additional information in the head-mounted display. Such special offers may include fresh products with approaching expiration dates, since selling those products allows the store owner to potentially reduce its shrinkage rate. Information may be obtained from a store management system or an ERP system, for which the store owner must implement certain rules (or preferences) which indicate under which circumstances (e.g., amount of products on stock, average selling rate of the product, days until expiration date, etc.) a special offer is made, and e.g., which discount the special offer implies (e.g., buy one, get one free). The store owner or the user/potential customer may implement certain rules on matching its rules on special offers (preferences) with rules or interests (i.e., preferences) of the user/potential customer. As a result of these matching activities, which may take place on server 302, AR information with the special offers are displayed to the user/potential customer.

### EXAMPLE 5

Following the preceding examples, the store owner may use data mining activities across its enterprise resource planning and customer resource management systems, using past sales data and customer information to identify buying patterns. These buying patterns may additionally be linked to buying patterns of the mobile phone's user, which are possibly made anonymous. The linkage may occur via using mobile payment solutions of the mobile phone or mobile coupons. When such a linkage has been established, the store owner may then create special offers particularly for the mobile phone's user to increase the likelihood of a sale. The special offers are then displayed as augmented reality information tied to the specific products in the head-mounted display, and, using the systems' connection to an electronic cashier system, are implemented in a timely manner so that the user can actually buy the products for that special price.

Examples of the claimed invention may comprise in any combination:

A method that may be executed in a mobile device, the method comprising the following steps: a) obtaining the current location of the mobile device; b) obtaining one or more images via a sensor; c) correlating the one or more images obtained from the sensor with reference data obtained from an image-object recognition database to identify objects within the one or more images; and d) obtaining augmented reality information that is linked to at least one of the objects from a server via a communication network and displaying the augmented reality information on a display of the mobile device.

The augmented reality information is adjusted to preferences stored in at least one preference database, whereas the preferences are preferences of the user of the mobile device or of a third party. These preferences are based on data gathered from linking (i) product information from mobile payments made, (ii) mobile coupons cashed by the user, or (iii) social media data analysis. The preference database is stored in a memory of the mobile device or is accessible via the interface of the communication network.

The information displayed via augmented reality emerges from comparing user preference data from a user preference database to preferences stored in one or more databases, and preference matching may take place. The databases mentioned may comprise results based on data mining activities, which may be conducted in/for the retail industry.

At least one of the databases mentioned is connected to at least one of a store management system, an enterprise resource planning (ERP) system, a customer relationship management system, and systems in general that allow the electronic analysis of product, sales and customer data, including social media data or a combination thereof, which may allow the electronic analysis of product, sales and customer data, including social media data, is connected to an electronic cashier system.

The method executed in the mobile device further allows specifying the location of the device by means of the objects identified via the images, which are compared to objects with location information stored in an image-object localization database accessible via a communication network.

The identification of objects may be prioritized with eye tracking. The server providing information to be displayed as augmented reality coordinates further databases comprising data on preferences, including at least one of product, sales, and customer data, or social media data, and the information to be displayed as augmented reality may be generated on the fly.

Examples include a mobile device for providing augmented reality information to a user, the mobile devices comprising: a) a locating means for obtaining the current location of the mobile device; b) at least one image sensor for obtaining one or more images; c) a correlating means for correlating the one or more images obtained from the sensor with reference data obtained from an image-object recognition database to identify objects within the one or more images; d) an augmented reality means for obtaining augmented reality information that is linked to at least one of the objects from a server via a communication network; and e) a display for displaying the augmented reality information.

One display of the mobile device is arranged in at least one glass of a pair of glasses. A first one of the at least one image sensors is arranged for recording the eyes of the user and at least a second one of the at least one image sensor is arranged for recording at least parts of the field of view of the user.

One of the at least one sensor for recording the eyes of the user may be integrated into one or more displays. Prioritization of object identification takes place from using data from the first image sensor recording the eyes of the user.

Other examples may include a system, comprising a server, a terminal, and a computer program to be executed in a memory of the terminal, wherein the terminal comprises: a) at least one sensor; b) at least one display; c) at least one network interface capable of communicating via a network; d) at least a processor coupled to the network interfaces, the sensors, and the displays; and e) a memory coupled to the at least one processor, the memory including instructions that cause the at least one processor to: 1) obtain the current location of the terminal; 2) obtain images via a sensor; 3) correlate images obtained from one sensor with reference data obtained from an image-object recognition database to identify objects within the images; and 4) display augmented reality information that is linked to certain objects on the terminal's display and obtained from a server via a communication network.

A terminal may be a mobile device. The information displayed via augmented reality is adjusted to preferences stored in a preference database, and the preferences may be preferences of a user of the terminal or of a third party. The preferences may be based on data gathered from linking (i) product information from mobile payments made, (ii) mobile coupons used by the user, or (iii) social media data analysis. The database may be stored in the memory of the terminal or the database is accessible via the interface of the communication network. The information displayed via augmented reality emerges from comparing user preference data from a user preference database to preferences stored in one or more further databases, and the information displayed via augmented reality and adjusted to user preferences stored in a user preference database may be compared to preferences stored in one or more further databases and a preference-matching takes place. One of the databases may comprise results based on data mining activities, which may be conducted in/for the retail industry.

At least one of the preference databases is connected to at least one of a store management system, an enterprise resource planning (ERP) system, a customer relationship management system, and systems that allow the electronic analysis of product, sales and customer data, including social media data or a combination thereof, and they may be connected to an electronic cashier system.

The system further comprises specifying the location of the device by means of the objects identified via the images, which are compared to objects with location information stored in an image-object localization database accessible via a communication network. The reference images are obtained from an image-object localization database stored in the memory of the terminal or a database which is accessible via the interface of a communication network. The identification of objects within the system may be prioritized with eye tracking.

The invention further includes a system with one or more servers and one or more terminals, wherein a server comprises: a) a network interface capable of communicating via a network; b) a processor coupled to the network interface; and a memory coupled to the processor, the memory including instructions that cause the processor to provide information to at least one terminal to: 1) receive reference image data from an image-object recognition database; and 2) receive information linked to certain objects on terminal's display from a server, wherein the information are based on preferences.

The server within this system or the mobile device correlate the image data which the terminal obtains from at least one sensor with reference image data from an image-object recognition database to identify objects within the images. The information sent to a terminal is compared in real-time to preferences stored in one or more preference databases. The information sent to a terminal is compared in real-time to preferences stored in one or more preference databases and a preference-matching takes place. These preferences are based on data gathered from linking at least one of product information from mobile payments made, mobile coupons cashed by the user, or social media data analysis. The preferences stored in one or more preference databases are of multiple users. One of the databases comprises results based on data mining activities, which may be conducted in/for the retail industry. A terminal within the system may be a mobile device. At least one of the one or more preference databases is connected to at least one of a store management system, an enterprise resource planning (ERP) system, a customer relationship management (CRM) system, and systems in general that allow the electronic analysis of product, sales and customer data, including social media data, or a combination thereof, which may be connected to an electronic cashier system. A server with the database containing information to be displayed as augmented reality coordinates further databases comprising data on preferences, including product, sales, and customer data, including social media data. The augmented reality data may be generated on the fly or stored within an AR information data base.

I claim:

1. A method that can be executed in a mobile device, the method comprising the following steps:
obtaining a current location of the mobile device,
obtaining one or more images via a sensor,
correlating the one or more images obtained from the sensor with reference data obtained from an image-object recognition database to identify objects within the one or more images,
obtaining augmented reality information that is linked to at least one of the objects from an augmented reality information database,
adjusting the augmented reality information to preferences stored in at least one preference data base,
comparing user preference data from a user preference database to preferences stored in one or more databases to obtain information to be displayed via augmented reality,
and displaying the information to be displayed via augmented reality on a display of the mobile device.

2. The method according to claim 1, wherein the preferences are based on data gathered from linking at least one of product information from mobile payments made, mobile coupons cashed by a user, and social media data analysis, and one of the one or more further databases comprising results based on data mining activities.

3. The method according to claim 1, wherein at least one of the at least one preference database is connected to at least one of a store management system, an enterprise resource planning (ERP) system, a customer relationship management system, and systems that allow the electronic analysis of product, sales and customer data, including social media data or a combination thereof.

4. The method according to claim 1, further specifying the current location of the mobile device by means of the objects identified via the images, which are compared to objects with location information stored in an image-object localization database.

5. The method according to claim 1, wherein the identification of objects is prioritized based on eye tracking.

6. A mobile device for providing augmented reality information to a user, the mobile devices comprising:
at least one sensor;
at least one network interface capable of communicating via a communication network;
at least a processor coupled to the network interfaces and the at least one sensor;
a locating means for obtaining a current location of the mobile device;
at least one image sensor for obtaining one or more images;
a correlating means for correlating the one or more images obtained from the image sensor with reference data obtained from an image-object recognition database to identify objects within the one or more images;
an augmented reality means for obtaining augmented reality information that is linked to at least one of the objects; and
a display for displaying the augmented reality information;
wherein at least the display is arranged in at least one glass of a pair of glasses.

7. The mobile device of claim 6, wherein a first one of the at least one image sensors is arranged for recording the eyes of the user and at least a second one of the at least one image sensor is arranged for recording at least parts of the field of view of the user.

8. The mobile device of claim 7, wherein a prioritization of object identification takes place from using data from the first image sensor recording the eyes of the user.

9. The mobile device according to claim 6, wherein the information displayed via augmented reality is adjusted to preferences stored in a preference database, the preference database is stored in a memory of the mobile device or is accessible via the interface of the communication network, and the information displayed via augmented reality emerges from comparing user preference data from a user preference database to preferences stored in one or more further databases and a preference matching may take place.

10. The mobile device according to claim 9, wherein the preferences are based on data gathered from linking at least one of product information from mobile payments made, mobile coupons used by the user, and social media data analysis; and one of the databases comprises results based on data mining activities.

11. The mobile device according to claim 9, wherein at least one of the preference databases is connected to at least one of a store management system, an enterprise resource planning (ERP) system, a customer relationship management system, and systems that allow the electronic analysis of product, sales and customer data, including social media data or a combination thereof.

12. The mobile device of claim 6, wherein the current location of the mobile device is specified by means of the objects identified via the images, which are compared to objects with location information stored in an image-object localization database.

13. A system with at least one server, wherein the at least one server comprises:
a network interface capable of communicating via a network with at least one terminal;
a processor coupled to the network interface; and
a memory coupled to the processor, the memory including instructions that cause the processor to provide information to the at least one terminal to:
receive reference image data from an image-object recognition database;
receive information linked to a first object on a display of the at least one terminal, wherein the information are based on preferences;
obtain augmented reality information that is linked to the first object from an augmented reality information database; and
send the augmented reality information to the at least one terminal.

14. The system according to claim 13 further comprising:
correlating the image data which the at least one terminal obtains from at least one sensor with reference image data from an image-object recognition database to identify objects within the images, and
wherein the information sent to the at least one terminal is compared in real-time to preferences stored in one or more preference databases, and preference matching takes place.

15. The system according to claim 13, wherein the preferences are based on data gathered from linking at least one of product information from mobile payments made, mobile coupons cashed by the user, and social media data analysis.

16. The system according to claim 13 wherein the preferences stored in one or more preference databases are of multiple users.

17. A system according to claim 14, wherein at least a further preference database comprises results based on data mining activities.

18. The system according to claim 13, wherein the at least one terminal is a mobile device.

19. The system according to claim 14, wherein at least one of the one or more preference databases is connected to at least one of a store management system, an enterprise resource planning (ERP) system, a customer relationship management (CRM) system, and systems in general that allow the electronic analysis of product, sales and customer data, including social media data, or a combination thereof.

20. The system according to claim 13, wherein the current location of the terminal is specified by means of the objects identified via the images, which are compared to objects with location information stored in an image-object localization database via the communications network.
